(19) United States
(12) Patent Application Publication
(10) Pub. No.: US 2003/0113542 A1
(43) Pub. Date: Jun. 19, 2003

(54) High surface area carbon composites

(75) Inventor: Julian Norley, Chagrin Falls, OH (US)

Correspondence Address: James R. Cartiglia, Graftech Inc., Suite 1100, 3102 West End Avenue, Nashville, TN, 37203, US

(73) Assignee: Graftech Inc., Lakewood, OH

(21) Appl. No.: 10/022,782

(22) Filed: Dec. 13, 2001

(51) Int. Cl. B32B 9/00

(52) U.S. Cl. 428/408

(57) ABSTRACT

Graphite sheets having enhanced surface area are prepared from flexible graphite sheets to which an activated carbon precursor has been added, followed by activation of the precursor. The sheets with enhanced surface area are useful in the formation of articles adapted for use in supercapacitors.

### TECHNICAL FIELD

This invention relates to sheets of materials prepared from flexible graphite sheets to which activated carbon precursors such as phenolic resins have been added, followed by baking and activation. These materials are useful in applications such as supercapacitors, battery electrodes, starting materials for fuel cell diffusion layers and catalyst carriers.

### BACKGROUND OF THE INVENTION

Carbon electrodes are being used in the emerging market of supercapacitors which are energy storage/pulse power devices used, for example, in memory protection systems for consumer electronics (VCR's, clock radio, CD's), electric vehicles, and un-interruptible power systems (UPS).

Supercapacitors, sometimes also called ultracapacitors and double-layer capacitors, are capable of rapidly charging to store significant amounts of energy and then delivering the stored energy in bursts on demand. To be useful, they must, among other properties, have low internal resistance, store large amounts of charge and be physically strong per unit weight. There are, therefore, a large number of design parameters that must be considered in their construction. It would be desirable to have procedures for producing component parts that would address these concerns such that the final supercapacitor assembly could be more effective on a weight and/or cost basis.

Supercapacitors of the double-layer type generally include two porous electrodes, kept from electrical contact by a porous separator. Both the separator and the electrodes are immersed within an electrolyte solution. The electrolyte is free to flow through the separator, which is designed to prevent electrical contact between the electrodes and short-circuiting of the cell. Current collecting plates are in contact with the backs of active electrodes. Electrostatic energy is stored in polarized liquid layers, which form when a potential is applied across the two electrodes. A double layer of positive and negative charges is formed at the electrode-electrolyte interface.

Since capacitors store energy in the form of a separated electrical charge, the greater the area for storing charge, and the closer the separated charges, the greater the capacitance. A conventional capacitor gets its area from plates of a flat, conductive material. To achieve high capacitance, this material can be wound in great lengths, and can sometimes have a texture imprinted on it to increase its surface area. A conventional capacitor separates its charged plates with a dielectric material, sometimes a plastic or paper film, or a ceramic. These dielectrics can be made only as thin as the available films or applied materials.

A supercapacitor gets its area from a porous carbon-based electrode material. The porous structure of this material allows its surface area to be much greater than can be accomplished using flat or textured films and plates. A supercapacitor's charge separation is determined by the size of the ions in the electrolyte which are attracted to the charged electrode. This charge separation (less than 10 angstroms) is much smaller than can be accomplished using conventional dielectric materials. The combination of enormous surface area and extremely small charge separation gives the supercapacitor its superior capacitance relative to conventional capacitors.

The use of graphite electrodes in electrochemical capacitors with high power and energy density provides a number of advantages, but economics and operating efficiency are in need of improvement. Fabrication of double layer capacitors with carbon electrodes is known. See, for example, U.S. Pat. No. 6,094,788, to Farahmandhi, et al., U.S. Pat. No. 5,859,761, to Aoki, et al., U.S. Pat. No. 2,800,616, to Becker, and U.S. Pat. No. 3,648,126, to Boos, et al. The art has been utilizing graphite electrodes for capacitors of this type for some time and is still facing challenges in terms of material selection and processing.

A continuing problem in many carbon electrode capacitors, including double-layer capacitors, is that the performance of the capacitor is limited because of the internal resistance of the carbon electrodes. Internal resistance is influenced by several factors, the most important of which is the chemical makeup of the material itself. While having a very favorable balance of properties, flexible graphite sheet electrodes could be improved if their electrical conductivity could be increased. Because high resistance translates to large energy losses in the capacitor during charging and discharge, and these losses further adversely affect the characteristic RC (resistance×capacitance) time constant of the capacitor and interfere with its ability to be efficiently charged and/or discharged in a short period of time, it would be desirable to provide construction materials and methods that would facilitate reductions in the internal resistance. Thermal conductivity is also important and any increase in this property would be an advantage.

To better understand the complexity of the above considerations, we present a brief description of graphite and the manner in which it is typically processed to form flexible sheet materials. Graphite, on a microscopic scale, is made up of layer planes of hexagonal arrays or networks of carbon atoms. These layer planes of hexagonally arranged carbon atoms are substantially flat and are oriented or ordered so as to be substantially parallel and equidistant to one another. The substantially-flat, parallel, equidistant sheets or layers of carbon atoms, usually referred to as graphene layers or basal planes, are linked or bonded together and groups thereof are arranged in crystallites. Highly-ordered graphite materials consist of crystallites of considerable size: the crystallites being highly aligned or oriented with respect to each other and having well ordered carbon layers. In other words, highly ordered graphites have a high degree of preferred crystallite orientation. It should be noted that graphites, by definition, possess anisotropic structures and thus exhibit or possess many characteristics that are highly directional, e.g., thermal and electrical conductivity and fluid diffusion. Sometimes this anisotropy is an advantage and at others it can lead to process or product limitations.

Briefly, graphites may be characterized as laminated structures of carbon, that is, structures consisting of superposed layers or laminae of carbon atoms joined together by weak van der Waals forces. In considering the graphite structure, two axes or directions are usually noted, to wit, the “c” axis or direction and the “a” axes or directions. For simplicity, the “c” axis or direction may be considered as the direction perpendicular to the carbon layers. The “a” axes or directions may be considered as the directions parallel to the carbon layers or the directions perpendicular to the “c” direction. The graphites suitable for manufacturing flexible graphite sheets possess a very high degree of orientation.

As noted above, the bonding forces holding the parallel layers of carbon atoms together are only weak van der Waals forces. Natural graphites can be chemically treated so that the spacing between the superposed carbon layers or laminae can be appreciably opened up so as to provide a marked expansion in the direction perpendicular to the layers, that is, in the “c” direction, and thus form an expanded or intumesced graphite structure in which the laminar character of the carbon layers is substantially retained.

Graphite flake which has been chemically or thermally expanded and more particularly expanded so as to have a final thickness or “c” direction dimension which is as much as about 80 or more times the original “c” direction dimension, can be formed without the use of a binder into cohesive or integrated sheets of expanded graphite, e.g. webs, papers, strips, foil tapes, or the like (typically referred to as “flexible graphite”). The formation of graphite particles which have been expanded to have a final thickness or “c” dimension which is as much as about 80 times or more the original “c” direction dimension into integrated flexible sheets by compression, without the use of any binding material, is believed to be possible due to the mechanical interlocking, or cohesion, which is achieved between the voluminously expanded graphite particles.

In addition to flexibility, the sheet material, as noted above, has also been found to possess a high degree of anisotropy to thermal and electrical conductivity and fluid diffusion, comparable to the natural graphite starting material due to orientation of the expanded graphite particles substantially parallel to the opposed faces of the sheet resulting from very high compression, e.g. roll processing. Sheet material thus produced has excellent flexibility, good strength and a very high degree or orientation. There is a need for processing that more fully takes advantage of these properties.

Briefly, the process of producing flexible, binderless anisotropic graphite sheet material, e.g. web, paper, strip, tape, foil, mat, or the like, comprises compressing or compacting under a predetermined load and in the absence of a binder, expanded graphite particles which have a “c” direction dimension which is as much as about 80 or more times that of the original particles so as to form a substantially flat, flexible, integrated graphite sheet. The expanded graphite particles that generally are worm-like or vermiform in appearance will, once compressed, maintain the compression set and alignment with the opposed major surfaces of the sheet. Properties of the sheets may be altered by coatings and/or the addition of binders or additives prior to the compression step. See U.S. Pat. No. 3,404,061 to Shane, et al. The density and thickness of the sheet material can be varied by controlling the degree of compression.

Lower densities are advantageous where surface detail requires embossing or molding. Lower densities aid in achieving good detail. However, strength, thermal conductivity and electrical conductivity are generally favored by more dense sheets. Typically, the density of the sheet material will be within the range of from about 0.04 g/cc to about 1.4 g/cc. It would be desirable to have a process that would permit improving thermal and electrical conductivity of these materials of reduced density.

Flexible graphite sheet material made as described above typically exhibits an appreciable degree of anisotropy due to the alignment of graphite particles parallel to the major opposed, parallel surfaces of the sheet, with the degree of anisotropy increasing upon roll pressing of the sheet material to increased density. In roll-pressed anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal, electrical and fluid diffusion properties of the sheet are very different, by orders of magnitude typically, for the “c” and “a” directions. It would be desirable to have a process which would permit increasing thermal and/or electrical conductivity when needed.

Graphite sheet is clearly attractive as a material for use in supercapacitors, because of its low cost, low electrical resistance and its availability in sheet form. Its major disadvantage is that it has a relatively low surface area (˜20 m/g). Thus, for flexible graphite sheet to be used in a supercapacitor material, its surface area would need to be increased, while its other attractive properties are not appreciably degraded.

### SUMMARY OF THE INVENTION

It is an object of the present invention to provide flexible graphite having improved through-sheet permeability.

It is another object of the invention to provide flexible graphite having a relatively high surface area.

It is yet another object of the invention to provide a binding/carrying medium for activated carbon precursors, such as resins, which may be baked and activated, and which medium will not adversely impact the functionality of the so-formed activated carbon.

These and other objects are accomplished by the present invention, which provides flexible graphite sheets to which an activated carbon precursor, such as a phenolic resin has been added, prior to the precursor being subjected to an activation step, i.e., a step which results in the transportation of the precursor into a carbon having a high surface area.

### DETAILED DESCRIPTION OF THE INVENTION

This invention is based upon the finding that when a flexible graphite sheet is impregnated with an activated carbon precursor such as a phenolic resin, the resin may be baked and then activated by exposure to an oxidation, steam or carbon dioxide. The novel high surface area flexible sheets which result exhibit new and novel properties which particularly adapt such sheets for use in constructing supercapacitors.

Central to all of the embodiments of the invention is the provision of a flexible graphite sheet material (also termed “foil”) to which has been added an activated carbon precursor.

Before describing the manner in which the invention improves current materials, a brief description of graphite and its formation into flexible sheets, which will become the primary substrate for forming the products of the invention, is in order.

Preparation of Flexible Graphite Foil

Graphite is a crystalline form of carbon comprising atoms covalently bonded in flat layered planes with weaker bonds between the planes. By treating particles of graphite, such as natural graphite flake, with an intercalant of, e.g. a solution of sulfuric and nitric acid, the crystal structure of the graphite reacts to form a compound of graphite and the intercalant. The treated particles of graphite are hereafter referred to as “particles of intercalated graphite.” Upon exposure to high temperature, the intercalant within the graphite decomposes and volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are therefore commonly referred to as worms, and are sometimes referred to herein as “particles of expanded graphite”. The worms may be compressed together into flexible sheets that, unlike the original graphite flakes, can be formed and cut into various shapes and provided with small transverse openings by deforming mechanical impact.

Graphite starting materials suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstrom units. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as carbons prepared by chemical vapor deposition and the like. Natural graphite is most preferred.

The graphite starting materials used in the present invention may contain non-carbon components so long as the crystal structure of the starting materials maintains the required degree of graphitization and they are capable of exfoliation. Generally, any carbon-containing material, the crystal structure of which possesses the required degree of graphitization and which can be intercalated and exfoliated, is suitable for use with the present invention. Such graphite preferably has an ash content of less than twenty weight percent. More preferably, the graphite employed for the present invention will have a purity of at least about 94%. In the most preferred embodiment, the graphite employed will have a purity of at least about 98%.

A common method for manufacturing graphite sheet is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfturic acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. The intercalation solution may also contain metal halides such as ferric chloride, and ferric chloride mixed with sulfuric acid, or a halide, such as bromine, as a solution of bromine and sulfuric acid or bromine, in an organic solvent.

The quantity of intercalation solution may range from about 20 to about 150 pph and more typically about 50 to about 120 pph. After the flakes are intercalated, any excess solution is drained from the flakes and the flakes are water-washed. Alternatively, the quantity of the intercalation solution may be limited to between about 10 and about 50 pph, which permits the washing step to be eliminated as taught and described in U.S. Pat. No. 4,895,713, the disclosure of which is also herein incorporated by reference.

The thus treated particles of graphite are sometimes referred to as “particles of intercalated graphite.” Upon exposure to high temperature, e.g. temperatures of at least about 160° C. and especially about 700° C. to 1000° C. and higher, the particles of intercalated graphite expand as much as about 80 to 1000 or more times their original volume in an accordion-like fashion in the c-direction, i.e. in the direction perpendicular to the crystalline planes of the constituent graphite particles. The expanded, i.e. exfoliated, graphite particles are vermiform in appearance, and are therefore commonly referred to as worms, and are sometimes referred herein as “particles of expanded graphite”. The worms may be compressed together into flexible sheets that, unlike the original graphite flakes, can be formed and cut into various shapes and provided with small transverse openings by deforming mechanical impact as hereinafter described.

Flexible graphite sheet and foil are coherent, with good handling strength, and are suitably compressed, e.g. by roll-pressing, to a thickness of about 0.075 mm to 3.75 mm and a typical density of about 0.1 to 1.4 grams per cubic centimeter (g/cc).

The instant invention contemplates significantly enhancing the surface area of flexible graphite foils by first impregnating the foils with an activated carbon precursor such as a resin, followed by baking and activation steps. The principal groups of resins suitable for use in this invention are epoxies, phenolics, urethanes and polymers of furfural and furfuryl alcohol. The preferred phenolics are phenol-formaldehyde and resorcinol-formaldehyde. Furan based polymers derived from furfural or furfuryl alcohol are also suitable. The resin system should preferably give a carbon yield in excess of about 20% and have a viscosity below about 200-300 centipoises (cps). In addition to solutions of phenolics in furfural and furfuryl alcohol, straight furfural or furfuryl alcohol can be used with a catalyst. For example, a solution of furfural and an acid catalyst could be impregnated in the graphite sheet.

After impregnation, the sheet is heated to dry and set the resin (at a temperature of, e.g., about 100° to about 250° C. or higher) and then heat treated (i.e., baked) preferably in an inert atmosphere, to about 500° C.-1600° C. to form glassy carbon.

The glassy carbon can then be activated by known techniques, such as by exposure to high temperature in the presence of oxygen, air, ozone, chlorine gas or, most advantageously, steam, for sufficient time to activate some or all of the glassy carbon (which oxidizes and, thus, activates preferentially to the flexible graphite sheet itself). The particular time and temperature of exposure are interrelated and depend on the nature of the oxidant and the time desired for the reaction. For instance, with air as the oxidant, a temperature of 450° C. will accomplish the same degree of activation in several days as ozone at 100° C. for less than 10 seconds. When steam is the oxidant, temperatures of about 700° C. or higher, for from about 5 to 15 minutes are appropriate.

Resins, such as phenolic resins, may be applied as surface coatings to flexible graphite sheets. However, simple surface coating has been shown to be relatively unsatisfactory. This is because if sufficient resin is applied to provide, upon activation, an effective high surface area activated carbon layer, the flexible graphite substrate may wrinkle or dimple during taking of the resin coating and drying (baking) steps. Accordingly, the present invention involves impregnation of the flexible graphite substrate with an activated carbon precursor material, rather than simple coating of the substrate.

In a typical resin impregnation step, the flexible graphite sheet is passed through a vessel and impregnated with the resin system from, e.g. spray nozzles, the resin system advantageously being “pulled through the mat” by means of a vacuum chamber. The resin is thereafter preferably dried, reducing the tack of the resin and the resin-impregnated sheet, which has a starting density of about 0.1 to about 1.1 g/cc, can thereafter processed to change the void condition of the sheet. One form of apparatus for continuously forming resin-impregnated and calendered flexible graphite sheet is shown in International Publication No. WO 00/64808, the disclosure of which is incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A high surface area carbon composite material in sheet form produced by impregnating a flexible graphite sheet with an activated carbon precursor material followed by activation of the said activated carbon precursor.

2. The carbon composite material of claim 1 wherein the said activated carbon precursor material is a phenolic resin which is baked after impregnation into the sheet.

3. The carbon composite material of claim 1, wherein the said activation is effected by air oxidation, steam treatment or CO₂ treatment.

4. The carbon composite material of claim 2, wherein prior to baking the flexible graphite sheet contains 30-45% by volume of cured resin.

5. The carbon composite material of claim 4, wherein after baking and prior to activation the baked flexible graphite sheet contains 15-30% by volume of resin.

6. The flexible graphite sheet of claim 2, wherein following activation the sheet contains 15-70% by mass of activated resin.

7. A process for preparing a high surface area carbon composite material comprising impregnating a flexible graphite sheet with an activated carbon precursor material followed by activating the said precursor.

8. The process of claim 7 wherein the carbon precursor material is a resin.

9. The precursor of claim 7 wherein activation is effected by air oxidation, steam treatment or CO₂ treatment.
